(19) United States
(12) Patent Application Publication
(10) Pub. No.: US 2026/0011890 A1
(43) Pub. Date: Jan. 8, 2026

(54) Busbar Spacer and Battery Module Including the Same

(71) Applicant: SK On Co., Ltd., Seoul (KR)

(72) Inventors: Seon Gi MIN, Daejeon (KR); Yun Joo NOH, Daejeon (KR); Gang U LEE, Daejeon (KR); Won Gab HWANG, Daejeon (KR)

(21) Appl. No.: 19/260,732

(22) Filed: Jul. 7, 2025

(30) Foreign Application Priority Data
Jul. 8, 2024 (KR) 10-2024-0089681

(51) Int. Cl. H01M 50/588; H01M 50/264; H01M 50/291; H01M 50/507

(52) U.S. Cl. CPC H01M 50/588; H01M 50/264; H01M 50/291; H01M 50/507

(57) ABSTRACT

A battery module comprising a cell assembly comprising a plurality of battery cells, a support frame disposed to face the cell assembly, a plurality of busbars disposed on the support frame and electrically connecting the plurality of battery cells, and a busbar spacer at least partially disposed between the plurality of busbars and provided to maintain the spacing between adjacent busbars among the plurality of busbars.

### CROSS-REFERENCE TO RELATED APPLICATION(S)

This patent document claims the benefit of priority to Korean Patent Application No. 10-2024-0089681 filed on Jul. 8, 2024, the entire disclosure of which is incorporated herein by reference.

### TECHNICAL FIELD

The present disclosure relates to a busbar spacer and a battery module including the same.

### BACKGROUND

Secondary batteries, unlike primary batteries, have the convenience of the ability to be charged and discharged, and thus receive significant attention as power sources for various mobile devices, electric vehicles, and the like.

These secondary batteries may include battery cells in which an electrode assembly formed by stacking cathode plates, anode plates, and separators or winding in a roll form is accommodated inside a case or housing together with an electrolyte. A plurality of battery cells may be stacked in a predetermined direction.

A plurality of busbars that electrically connect the battery cells to each other may be provided. The busbars may be supported by a support frame. If the internal temperature of the battery cells increases to a critical value, a thermal runaway event can occur inside the housing, which may cause the support frame which supports the busbars to melt.

If the support frame melts, the separations between the plurality of busbars may be eliminated, allowing contact between neighboring busbars or allowing busbars to contact adjacent electrically conductive members, resulting in a short circuit.

Accordingly, a structure that may prevent a short circuit of a busbar when a high temperature or thermal runaway event occurs inside a battery module or battery pack is desired.

### SUMMARY

Provided herein is a busbar spacer and battery module containing the same. In some embodiments the busbar space and battery module containing the same are provided for prevention of a short circuit between a plurality of busbars or battery cells.

According to one aspect of the present disclosure, an arrangement of a plurality of busbars may be supported when a high temperature event such as thermal runaway or the like occurs.

In some embodiments of the present disclosure, a battery module comprises a cell assembly comprising: a plurality of battery cells; a support frame disposed on at least one side of the cell assembly; a plurality of busbars disposed on the support frame and electrically connecting the plurality of battery cells; and a busbar spacer at least partially disposed between the plurality of busbars and separating adjacent busbars among the plurality of busbars.

In one embodiment, a melting point temperature of the busbar spacer may be higher than a melting point temperature of the support frame.

In one embodiment, the plurality of busbars and the busbar spacer may be disposed to face each other with the support frame interposed therebetween.

In one embodiment, the busbar spacer may be disposed between the support frame and the cell assembly, and may at least partially protrude to be disposed between the plurality of busbars.

In one embodiment, the busbar spacer may include a spacer body provided to face the support frame; and a protrusion protruding from the spacer body toward a gap between the plurality of busbars.

In one embodiment, the protrusion may include a first protrusion supporting a first surface of the plurality of busbars, facing the cell assembly; and a second protrusion protruding further than the first protrusion and supporting a second surface opposite to the first surface.

In an embodiment, the first protrusion may comprise a first support contacting the first surface of the plurality of busbars, the second protrusion may comprise a second support contacting the second surface of the plurality of busbars, and at least one of the plurality of busbars may be disposed and inserted between the first support and the second support.

In an embodiment, the support frame may include a spacer hole provided between the plurality of busbars so that at least a portion of the protrusion can be inserted thereinto.

In an embodiment, the first protrusion and the second protrusion may be disposed alternately.

In an embodiment, at least one first protrusion and at least one second protrusion may be provided, and the one or more first protrusion may be disposed between a plurality of the one or more second protrusions.

In an embodiment, the second support may comprise a structure including a hook on which edges of a plurality of adjacent busbars are caught.

In an embodiment, the spacer body may have a height greater than a height of the plurality of busbars.

In some embodiments of the present disclosure, a battery module comprises a cell assembly, comprising a plurality of battery cells; a support frame disposed to face the cell assembly; a plurality of busbars disposed on the support frame and comprising a first busbar and a second busbar adjacent to each other; and a busbar spacer at least partially disposed between the first busbar and the second busbar, and coupling the first busbar and the second busbar to each other.

In an embodiment, the plurality of busbars and the busbar spacer may be disposed to face each other with the support frame interposed therebetween, and the busbar spacer may include a spacer body disposed between the support frame and the cell assembly; and a protrusion protruding from the spacer body to a space between the first busbar and the second busbar.

In an embodiment, the protrusion may include a first protrusion supporting a first surface of the first busbar and the second busbar; and a second protrusion at least partially disposed between the first busbar and the second busbar, and supporting a second surface of the first busbar and the second busbar, opposite to the first surface.

In an embodiment, the first busbar and the second busbar may be configured to be coupled to each other while being at least partially interposed between the first protrusion and the second protrusion.

By using the busbar spacers and battery modules as disclosed herein, short circuits may be prevented in battery packs or secondary batteries prepared with the same.

### BRIEF DESCRIPTION OF DRAWINGS

The above and other objects, features and other advantages of the present disclosure will be more clearly understood from the following detailed description taken in conjunction with the accompanying drawings.

FIG. 1 depicts a perspective view of a battery module according to an embodiment of the present disclosure.

FIG. 2 depicts an exploded perspective view of a battery module according to an embodiment of the present disclosure.

FIG. 3 depicts a busbar assembly according to an embodiment of the present disclosure.

FIG. 4 depicts a front-view of a busbar assembly according to an embodiment of the present disclosure.

FIG. 5 depicts a perspective view of a busbar assembly according to an embodiment of the present disclosure.

FIG. 6 is an exploded perspective view of the busbar assembly of FIG. 5 according to an embodiment of the present disclosure.

FIG. 7 depicts an enlarged view of part A of FIG. 6 according to an embodiment of the present disclosure.

FIG. 8 depicts a busbar spacer mounted on a support frame according to an embodiment of the present disclosure.

FIG. 9 depicts a perspective view of the busbar spacer of FIG. 8 according to an embodiment of the present disclosure.

FIG. 10 depicts a cross-section of the busbar spacer of FIG. 8 taken along line I-I′ according to an embodiment of the present disclosure.

FIG. 11 depicts a cross-section of the busbar spacer of FIG. 8 taken along line II-II′ according to an embodiment of the present disclosure.

FIG. 12 depicts a cross-section of the busbar spacer of FIG. 8 taken along line III-III′ according to an embodiment of the present disclosure.

FIG. 13 depicts a busbar assembly wherein the support frame has melted and disappeared.

FIG. 14 depicts the busbar assembly of FIG. 13 as viewed from the opposite side.

### DETAILED DESCRIPTION

Hereinafter, embodiments of the present disclosure will be provided in detail. However, these are merely illustrative, and the present disclosure is not limited to the specific embodiments described by way of example. It is to be understood that the components of the embodiments, as generally described and illustrated in the figures herein, may be arranged and designed in a wide variety of different configurations in addition to the described embodiments. Thus, the following description of the embodiments represented in the figures is not intended to limit the scope of the embodiments as claimed, but is merely representative of some example embodiments. Accordingly, shapes and sizes of the elements in the drawings may be exaggerated for clarity of description.

Furthermore, described features, characteristics, or structures may be combined in any suitable manner in one or more embodiments. In the following description, numerous specific details are provided for a thorough understanding of embodiments. A person having ordinary skill in the relevant art will recognize, however, that the various embodiments may be practiced without one or more of the specific details, or with other methods, components, materials, etc. In other instances, well-known structures, materials, or operations are not shown or described in detail to avoid obfuscation and improve clarity.

An expression used in the singular encompasses the expression of the plural, unless it has a clearly different meaning in the context. The terms, “include,” “comprise,” “is configured to,” or the like are used to indicate the presence of features, numbers, steps, operations, elements, portions or combinations thereof, and do not exclude the possibilities of other combination or the addition of one or more features, numbers, operations, elements, portions or combinations thereof.

In described embodiments, terms such as an upper side, an upper portion, a lower side, a lower portion, a side surface, a front surface, a rear surface, or the like, are represented based on the directions in the drawings, and may be used differently if the direction of an element is changed.

The terms “first,” “second,” and the like may be used to distinguish one element from the other, and may not limit a sequence and/or an importance, or others, in relation to the elements. In some embodiments, a first element may be referred to as a second element, and similarly, a second element may be referred to as a first element without departing from the scope of right in the example embodiments.

Example systems and methods herein provide one or more busbar spacers and battery modules that comprise multiple battery cells (e.g., rechargeable secondary battery cells). According to various embodiments, a battery pack may be provided comprising an arrangement of one or more battery modules. Each battery module of the one or more battery modules may comprise a plurality of battery cells stacked in a first direction.

Furthermore, battery packs and battery modules described herein may ensure safety and longevity of secondary batteries. The structures described herein may allow for the prevention of short circuits in secondary batteries experiencing high internal temperatures or thermal runaway events.

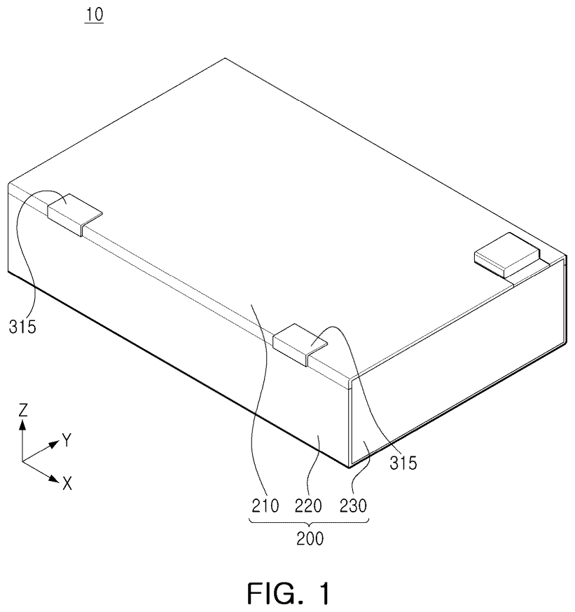

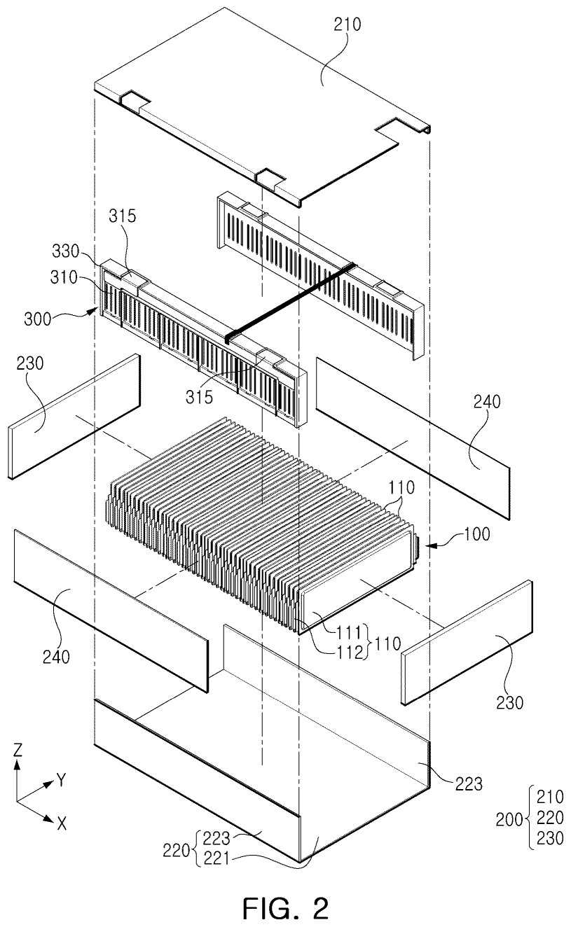

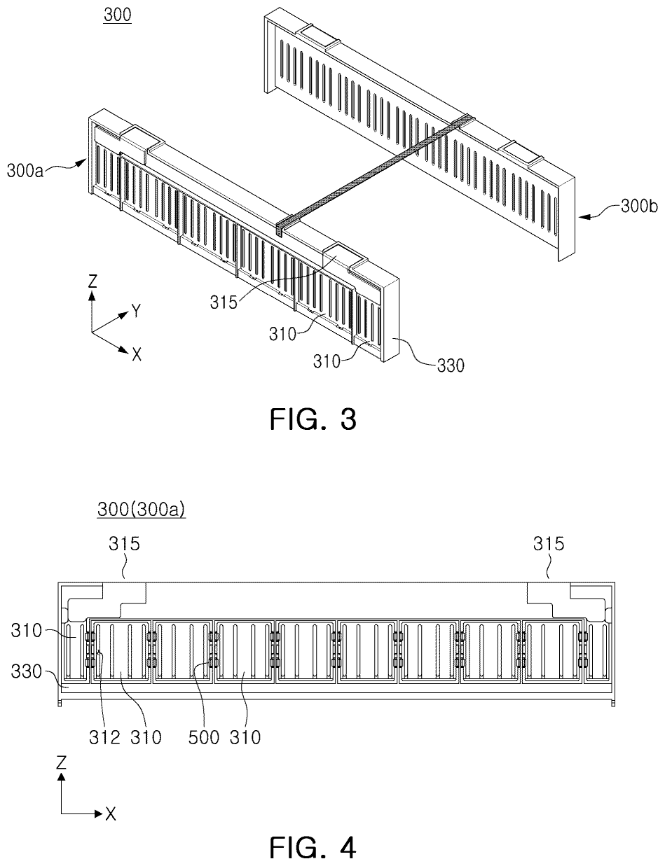

FIG. 1 is a perspective view of a battery module according to an embodiment, FIG. 2 is an exploded perspective view of a battery module according to an embodiment, FIG. 3 is a drawing illustrating a busbar assembly according to an embodiment, and FIG. 4 is a drawing of a busbar assembly viewed from the front according to an embodiment.

Referring to FIGS. 1 to 4 together, a battery module 10 according to an embodiment may comprise a cell assembly 100 including a plurality of battery cells 110, a support frame 330 disposed to face the cell assembly 100, a plurality of busbars 310 disposed in the support frame 330 and electrically connecting the plurality of battery cells 110, and a busbar spacer 500 at least partially disposed between the plurality of busbars 310 to separate adjacent busbars 310 among the plurality of busbars 310. In this case, the busbar spacer 500 ‘separating adjacent busbars’ may mean at least one of ‘maintaining the gap between neighboring busbars 310,’ ‘preventing short circuits between busbars 310 by spacing the neighboring busbars 310 apart from each other,’ and ‘forming a gap or space between neighboring busbars 310.’ For example, the busbar spacer 500 may prevent adjacent busbars 310 from contacting each other. In one embodiment, the busbar spacer may prevent adjacent busbars from electrically contacting each other.

In detail, the battery module 10 may comprise a cell assembly 100 comprising a plurality of battery cells 110, a housing 200 having a receiving space for receiving the cell assembly, and a busbar assembly 300 electrically connected to the battery cells 110. In addition, the battery module 10 may include a circuit unit (not illustrated) that detects various electric signals of the battery cells 110 and a connector (not illustrated) that is connected to the circuit unit and connected externally.

A plurality of battery cells 110 accommodated in the battery module 10 may be stacked in one direction (X-axis direction) to form at least a portion of a cell assembly 100. Each battery cell 110 may output or store electrical energy. In the cell assembly 100, the battery cells 110 may be electrically connected to each other through a busbar assembly 300.

The plurality of battery cells 110 may be configured to convert chemical energy into electrical energy and supply power to an external circuit, or to receive power from the outside and change electrical energy into chemical energy and store electricity. For example, the battery cell 110 may be configured as a nickel metal hydride (Ni-MH) battery or a lithium ion (Li-ion) battery that may be charged and discharged.

A plurality of battery cells 110 may be provided by accommodating an electrode assembly (not illustrated) formed by stacking cathode plates and anode plates, respectively. The electrode assembly may be configured in a form in which the cathode plates and the anode plates are stacked with a separator interposed while wide surfaces thereof face each other. The separator may be configured to prevent electrical short-circuiting between the cathode plates and the anode plates and to allow ion flow. For example, the separator may include a porous polymer film or a porous nonwoven fabric.

In addition, the electrode assembly may be accommodated in a case in various ways, such as a stacking type, a zigzag folding type, a stack-folding type, and the like, in a jelly roll type formed by winding in a predetermined direction.

The plurality of battery cells 110 may be pouch-type, prismatic-type or cylindrical-type secondary batteries depending on the structure of the case.

The battery cell 110 of the present disclosure may include a case 111 that accommodates the electrode assembly and a lead tab 112 that protrudes from at least one side of the case and is electrically connected to a busbar 310 to be described later.

In addition, the cell assembly 100 may further include a protective pad (not illustrated). The protective pad may be disposed at least partially between the plurality of battery cells 110 so that wide surfaces thereof face each other therebetween. The protective pad may prevent damage to other battery cells due to an event (for example, a situation in which high-temperature gas or flame is generated, or a battery cell expands abnormally). For example, the protective member may include a material capable of heat blocking to prevent heat propagation between neighboring battery cells 110. Alternatively, the protective member may include a material capable of applying surface pressure to the battery cell 110, and may perform a function of suppressing expansion of the battery cell 110.

A plurality of battery cells 110 comprising a cell assembly 100 may be electrically connected to each other through a busbar assembly 300 via lead tabs 112. At least a portion of the busbar assembly 300 may face the cell assembly 100 in a direction perpendicular to the cell stacking direction (Y-axis direction).

The housing 200 provides an internal space in which one or more cell assemblies 100 may be accommodated. The housing 200 may be formed of a material having a predetermined rigidity to protect the cell assembly 100 and other electrical components accommodated in the internal space from external impact. For example, the housing 200 may include a metal material such as aluminum.

The housing 200 may include a first cover 210, a second cover 220, and an end plate 230 that covers the side and is disposed facing the cell assembly 100 in the height direction (Z-axis direction).

The first cover 210 is disposed at the upper side of the cell assembly 100, and thus, may also be referred to as an “upper cover.”

The second cover 220 may be disposed at the lower side of the cell assembly 100 to support the same. The second cover 220 may be disposed facing the upper cover 210 and may include a lower plate 221 that supports the lower side of the cell assembly 100 and a side plate 223 that is disposed at the side of the cell assembly 100 and in the longitudinal direction (Y-axis direction) of the cell assembly 100.

In this embodiment, the second cover 220 is disposed at the lower side of the cell assembly 100, and thus, may also be referred to as a “lower cover.”

The end plate 230 may cover a portion that is not covered by the upper cover 210 and the lower cover 220. For example, the end plates 230 may be provided in a pair and disposed to cover both side surfaces in the stacking direction (X-axis direction) of the cell assembly 100.

In addition, the battery module of the present disclosure may comprise an insulating cover 240 formed of an electrically insulating material and disposed between the busbar assembly 300 and the housing 200 [the side plate 223] to electrically protect the battery cell 110.

For example, the insulating cover 240 may be disposed between the busbar assembly 300 and the housing 200 to face the busbar assembly 300. The insulating cover 240 may include an insulating material, thereby preventing electrical connection from occurring between the busbar assembly 300 and the housing 200. For example, the insulating cover 240 may be formed of a plastic injection molded product including polypropylene or modified polyphenylene oxide (MPPO). However, the material of the insulating cover 240 is not limited thereto. As the insulating cover 240 is disposed, an electrical short circuit may be prevented from occurring between the cell assembly 100 and the housing 200, or between the busbar 310 and the housing 200.

However, the structure of the housing 200 is not limited thereto, and any shape is possible as long as it may have an internal space in which at least one cell assembly 100 may be accommodated. For example, the housing 200 may be formed integrally with the upper cover 210 and may be configured as an integral monoframe with both side surfaces open.

The busbar assembly 300 may be connected to the circuit unit. The circuit unit may be connected to the cell assembly 100 to detect the operating status, environmental status, humidity, current pressure, or the like of the battery cells 110. The connector may connect the circuit unit and the outside of the battery module 10, for example, a Battery Management System (BMS) to each other, to transmit and receive information about the battery cell 110 to and from the outside. The connector may be exposed to the outside of the battery module 10 through a cavity formed in the housing 200.

The busbar assembly 300 may include a busbar 310 that electrically connects one battery cell 110 to another battery cell 110, and a support frame 330 that supports the busbar 310. The busbar assembly 300 and the circuit unit are illustrated together in a disposed state, but the busbar assembly 300 in the present disclosure is not limited thereto, and all may be included as long as the busbar 310 and the support frame 330 supporting the same may be included.

The busbar assembly 300 may be disposed to face at least one side of the battery cell 110. For example, according to an embodiment, the busbar assembly 300 may include a first busbar assembly 300a disposed on one side of the battery cell 110 and a second busbar assembly 300b disposed on the other side thereof. In this case, the first busbar assembly 300a and the second busbar assembly 300b may have a difference in the position at which they are disposed with respect to the battery cell 110, but there may be no difference in the detailed configuration. Although the present disclosure describes that the busbar assembly 300 is disposed on both sides of the battery cell 110, the present disclosure is not limited thereto.

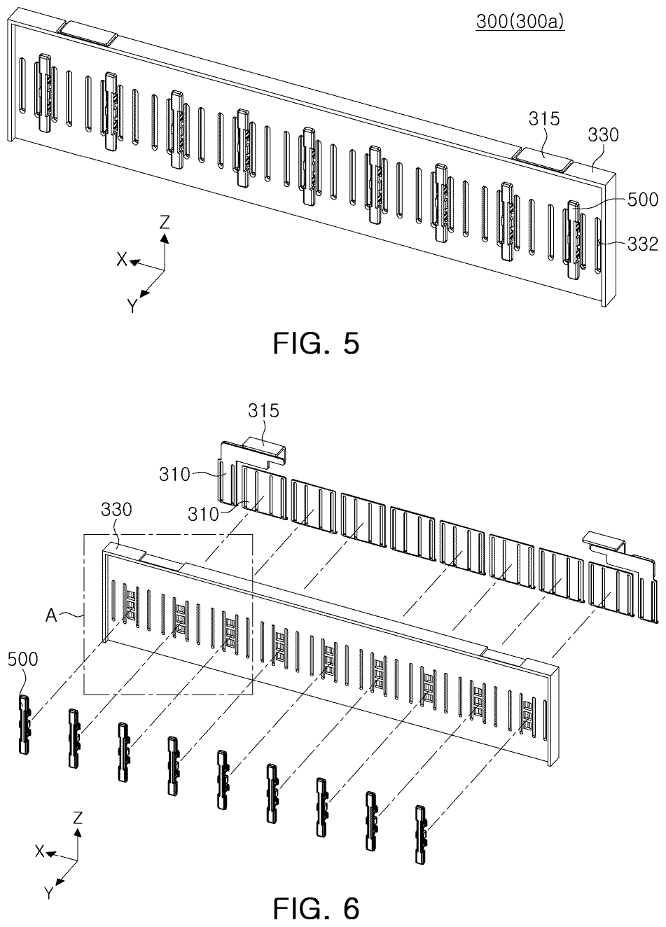

Hereinafter, the busbar assembly 300 will be described in detail with additional reference to FIGS. 5 and 6.

FIG. 5 is a perspective view of a busbar assembly, and FIG. 6 is an exploded perspective view of FIG. 5.

In an embodiment, one or more of the busbars 310 of the busbar assembly 300 may include a terminal portion 315 that may be electrically connected to a power source outside the battery module 10. The terminal portion 315 may be exposed to the outside of the battery module 10 through a hole formed in the housing 200.

In the case of the busbars 310, a plurality of busbars 310 may be coupled to a support frame 330. The support frame 330 may be formed of an electrically insulating material to prevent an unintended short circuit from occurring between the plurality of busbars 310. The support frame 330 may face at least one side of the cell assembly 100.

The busbar 310 is formed of a conductive material, and may electrically connect a plurality of battery cells 110 to each other.

In detail, the busbar 310 has a slit hole 312 formed therein, and the lead tab 112 of the battery cell 110 may be inserted into the slit hole 312 to be electrically connected. In this case, various welding methods, including laser welding, may be applied to connect the busbar 310 and the lead tab 112. However, the connection method is not limited to welding, and any connection method that may electrically conduct two metallic materials may be used.

The support frame 330 is formed of an electrically insulating material, and may prevent a short circuit between the plurality of busbars 310. An insertion hole 332 that communicates with the slit hole 312 of the busbar 310 may be formed in the support frame 330. Therefore, the lead tab 112 of the battery cell 110 may be inserted into the slit hole 312 while passing through the insertion hole 332.

The plurality of busbars 310 may be disposed of at a predetermined interval from the support frame 330. However, when an event such as thermal runaway occurs, if the support frame 330 melts, a short circuit may occur when the plurality of busbars 310 come into contact with each other. Accordingly, according to an embodiment, a busbar spacer 500 disposed between the plurality of busbars 310 may be included.

The busbar spacer 500 may be disposed between two neighboring busbars 310 among the plurality of busbars 310 to support while maintaining the interval between the two neighboring busbars 310. The busbar spacer 500 may be fixed by being inserted at least partially into a spacer hole 335 formed in the support frame 330. The spacer hole 335 may be formed between a plurality of busbars 310.

For example, according to an embodiment, the support frame 330 may include a spacer hole 335 formed between a plurality of busbars 310 so that at least a portion of the protrusion 520 may be inserted. The busbar spacer 500 may be secured to the support frame 330 while the protrusion 520 is inserted into the spacer hole 335.

According to an embodiment, the plurality of busbars 310 and the busbar spacer 500 may be disposed to face each other with the support frame 330 interposed therebetween. The support frame 330 is disposed between the cell assembly 100 and the plurality of busbars 310, and the busbar spacer 500 may be disposed between the support frame 330 and the cell assembly 100.

In detail, in the drawing, the plurality of battery cells 110 are stacked in the first direction (X-axis direction), and the plurality of busbars 310 may be disposed on the support frame 330 to be spaced apart from each other along the first direction (X-axis direction). In this case, the busbar spacer 500 may be disposed between the busbars 310 that are adjacent to each other among the plurality of busbars 310 based on the first direction (X-axis direction).

In addition, the busbar spacer 500 may be disposed between the support frame 330 and the cell assembly 100, but may protrude so that at least a portion thereof is disposed between the plurality of busbars 310.

The busbar spacer 500 may include a spacer body 510 and a protrusion 520 protruding from the spacer body 510.

The spacer body 510 may be disposed between the support frame 330 and the battery cell 110. The spacer body 510 may be extended further than the busbar 310 in the height direction (Z-axis direction). For example, at least a portion of the spacer body 510 may be disposed at least one of the upper or lower portions of the plurality of busbars 310. For example, the height of the spacer body 510 is provided to be greater than the height of the plurality of busbars 310, so that the upper end and lower end of the spacer body 510 may be disposed above and below the plurality of busbars 310, respectively.

Therefore, the spacer body 510 may not only increase the contact area with the support frame 330, but also support the upper and lower sides of the busbar 310 when the support frame 330 is melted, thereby minimizing contact between adjacent members.

For example, the height of the spacer body 510 may be provided to be greater than the height of the plurality of busbars 310.

The protrusion 520 may protrude from the spacer body 510 into the gap between the two adjacent busbars 310 to support the two adjacent busbars 310.

In addition, the protrusion 520 according to the present disclosure may fix the two adjacent busbars 310 to each other. The busbar spacer 500 may fix adjacent busbars 310 to each other so that the busbars 310 may maintain a distance apart from each other even if the support frame 330 is melted. In detail, the busbar spacer 500 may maintain the arrangement of a plurality of busbars 310 even if the support frame 330 is removed.

Hereinafter, the coupling structure of the busbar spacer 500 will be described in more detail with reference to the drawings.

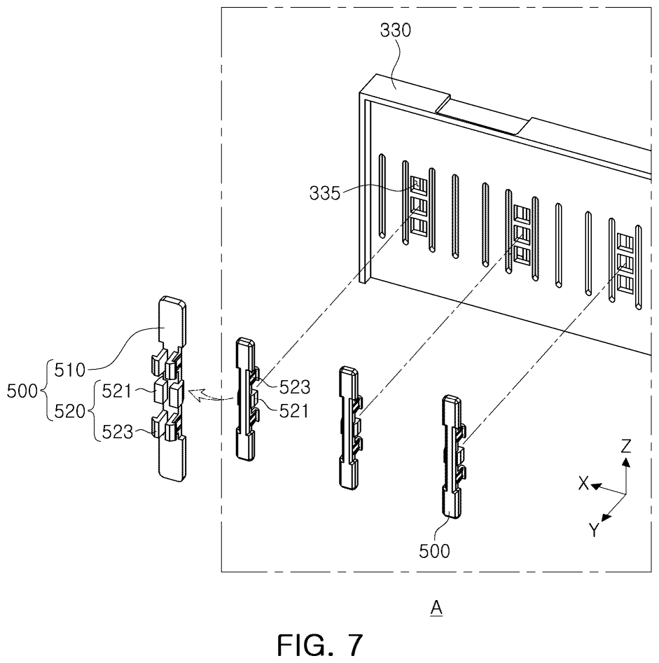

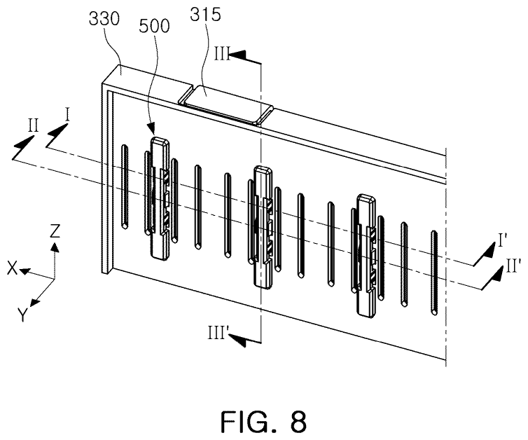

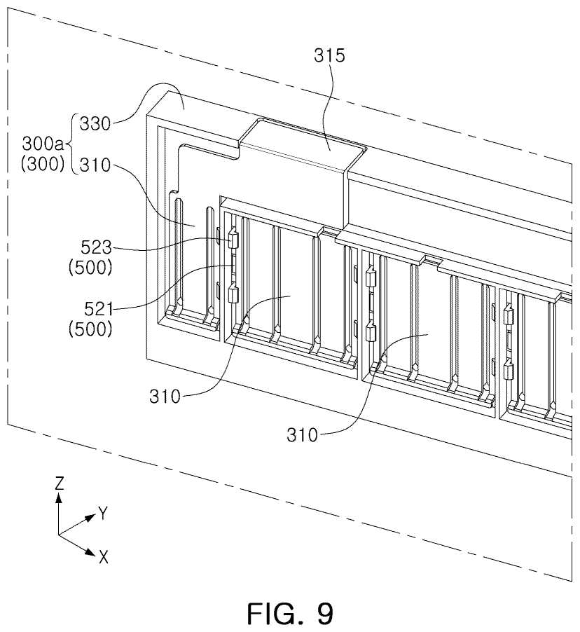

FIG. 7 is an enlarged view of part A of FIG. 6, FIG. 8 is a drawing illustrating the busbar spacer mounted on the support frame, and FIG. 9 is a perspective view of FIG. 8 viewed from another direction.

Referring to FIGS. 7 and 9 together, the busbar spacer 500 according to an embodiment may be mounted by having at least a portion inserted into a spacer cavity 335 formed in the support frame 330.

The busbar spacer 500 may comprise a spacer body 510 supported by contacting the support frame 330 on one side and a protrusion 520 protruding from the spacer body 510 and at least a portion of which is disposed between a plurality of busbars 310. The protrusion 520 may be disposed between a plurality of busbars 310 while being inserted into the spacer hole 335.

According to an embodiment, a plurality of protrusions 520 are provided in the height direction (Z-axis direction) and may be inserted with the busbar 310 interposed therebetween based on a predetermined direction (for example, Y-axis direction). For example, by supporting one side and the other side of the busbar 310 respectively and causing the busbar to be inserted between the protrusions 520, two adjacent busbars 310 may be supported and fixed to each other.

In detail, the protrusion 520 may include first protrusions 521 supporting first surfaces (surfaces facing the support frame 330 or the cell assembly 100, or surfaces in the −Y-axis direction) of the plurality of busbars, and second protrusions 523 supporting second surfaces (surfaces opposite to the first surfaces or surfaces in the +Y-axis direction) of the busbars. In this way, the second protrusion 523 may be more protruded than the first protrusion 521 so that at least a portion thereof may be disposed on the second surface of the busbar 310.

Therefore, the busbar 310 may be disposed between the first protrusion 521 and the second protrusion 523 based on the protrusion direction (Y-axis direction) of the protrusion 520.

The first protrusion 521 and the second protrusion 523 may be arranged in the height direction (Z-axis direction) in the spacer body 510.

Hereinafter, referring to the drawings, the dispose structure between the busbar spacer 500 and the busbar 310 will be described in more detail.

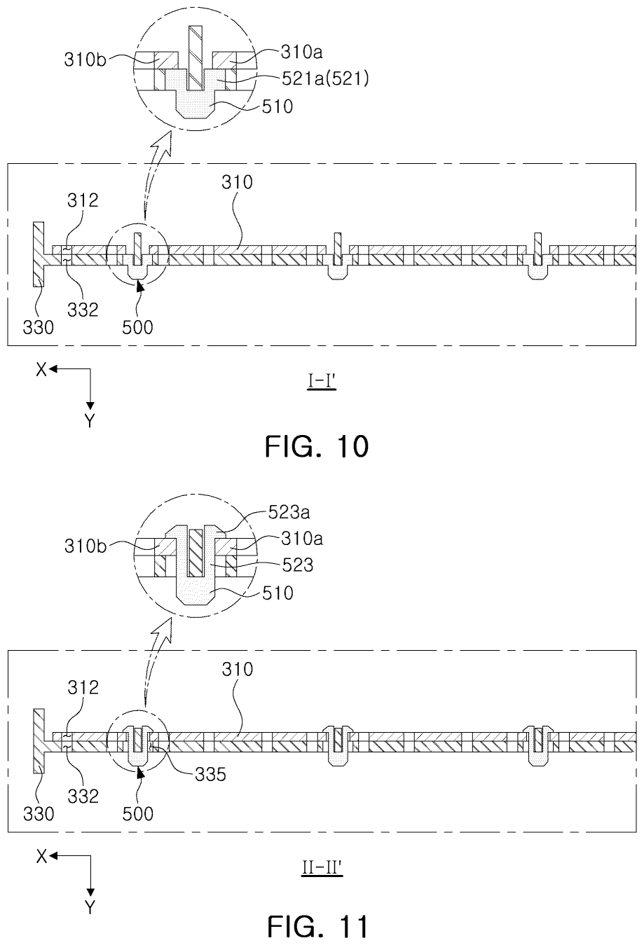

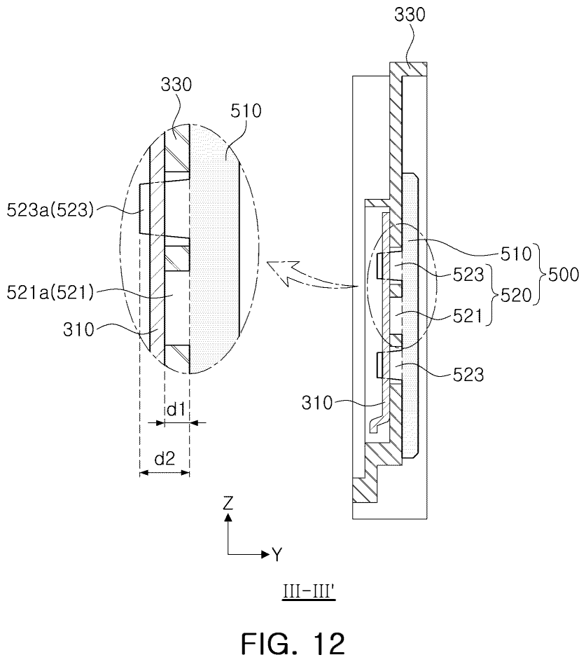

FIG. 10 is a cross-section taken along I-I′ of FIG. 8, FIG. 11 is a cross-section taken along II-II′ of FIG. 8, and FIG. 12 is a cross-section taken along III-III′ of FIG. 8. FIG. 10 is a cross-section taken along the first protrusion 521, and FIG. 11 is a cross-section taken along the second protrusion 523.

Referring to FIGS. 10 and 11, the second protrusion 523 protrudes further than the first protrusion 521, so that the busbar 310 may be disposed therebetween.

In detail, the first protrusion 521 may include a first support 521a that contacts the first surface of the busbar 310, and the second protrusion 523 may include a second support 523a that contacts the second surface of the busbar 310. At this time, at least one of the plurality of busbars 310 may be disposed and inserted between the first support 521a and the second support 523a.

In more detail, in the present disclosure, the first support 521a and the second support 523a may refer to the portions where the first protrusion 521 and the second protrusion 523 contact the busbar 310, respectively, and may refer to the terminal portions of the first protrusion 521 and the second protrusion 523, respectively.

The first support 521a of the first protrusion 521 may support the first faces of the two adjacent busbars 310. The second support 523a of the second protrusion 523 may support the second faces of the two adjacent busbars 310. For example, the second support 523a may be provided in a hook or flange that extends in a direction (X-axis direction) toward the two adjacent busbars 310.

According to an embodiment, the second support 523a may comprise a hook provided to catch the edge of the busbar 310 to support the busbar 310 from being detached outward (in the −Y-axis direction).

For example, the first protrusion 521 may support the busbar 310 outwardly (in the −Y-axis direction), and the second protrusion 523 may support the busbar 310 inwardly (in the +Y-axis direction).

In this way, two adjacent busbars 310 may be fixed to each other by being inserted between the first support 521a of the first protrusion 521 and the second support 523a of the second protrusion 523.

Meanwhile, according to an embodiment as illustrated in FIGS. 11 and 12, the plurality of busbars 310 may include a first busbar 310a and a second busbar 310b disposed adjacent to the first busbar 310a. In this case, at least a portion of the busbar spacer 500 may be disposed between the first busbar 310b and the second busbar 310b to couple the first busbar 310a and the second busbar 310b to each other.

In more detail, the first busbar 310a and the second busbar 310b may be provided to be at least partially interposed between the first protrusion 521 and the second protrusion 523 and be coupled to each other.

In this case, ‘coupled to each other’ may mean that adjacent busbars 310, for example, the first busbar 310a and the second busbar 310b, are fixed to the support frame 330 so that they do not come close to each other even without the support frame 330.

FIG. 12 is a drawing taken in cross section based on the height direction (Z-axis direction) of the spacer body 510. Referring to FIG. 12, the protrusion length d2 of the second protrusion 523 may be greater than the protrusion length d1 of the first protrusion 521 based on the spacer body 510.

In addition, according to an embodiment, each of the first protrusion 521 and the second protrusion 523 may be provided as at least one or more. In addition, to prevent the force applied to the busbar 310 from being biased, the first protrusion 521 and the second protrusion 523 may be disposed alternately.

For example, the first protrusion 521 and the second protrusion 523 are each provided as at least one or more, and the first protrusion 521 may be disposed between a plurality of the second protrusions 523.

In the drawing, the first protrusion 521 is depicted as being disposed at the center portion in the height direction (Z-axis direction) and disposed between the second protrusions 523, but the present disclosure is not limited thereto. For example, even if the second protrusion 523 is disposed at the center portion in the height direction and disposed between the first protrusions 521, it may all fall within the present disclosure.

Meanwhile, in the present disclosure, the spacer body 510 is illustrated as being disposed between the support frame 330 and the cell assembly 100, but the present disclosure is not limited thereto, and may be disposed between a plurality of busbars 310 and the housing 200 (in detail, the side plate 223).

In detail, the busbar spacer 500 may be disposed on the outside of the busbar assembly 300 rather than the inside thereof, as long as it may support a spaced state of a plurality of busbars 310. If the busbar spacer 500 is disposed outside the busbar assembly 300, the first support 521a may be provided to support the second surface of the busbar 310 and the second support 523a may be provided to support the first surface of the busbar 310.

In addition, as described above, the busbar spacer 500 of the present disclosure may be provided to support a plurality of busbars 310 even if the support frame 330 is melted. This will be described below with reference to the drawings.

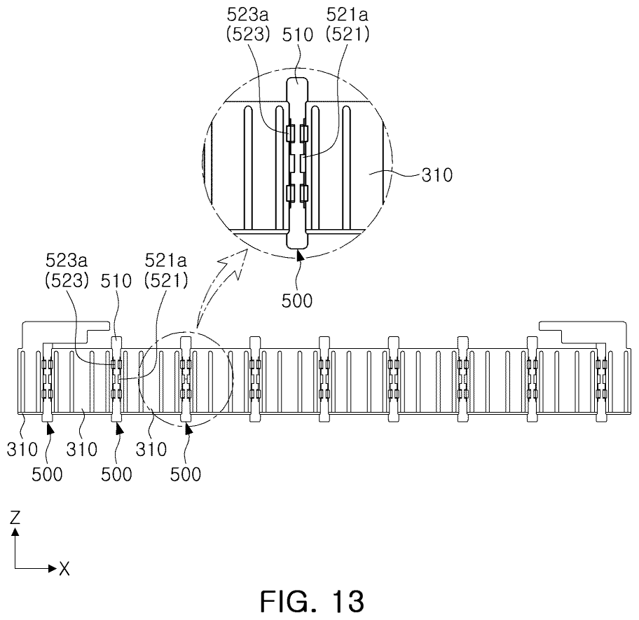

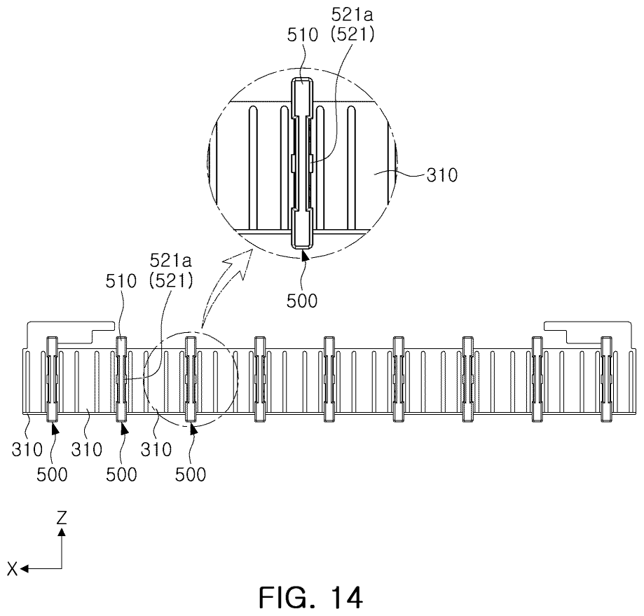

FIG. 13 is a drawing illustrating that the support frame in FIG. 4 has melted and disappeared, and FIG. 14 is a drawing illustrating the melted support frame of FIG. 13 from a view of the opposite side of busbar assembly 300.

According to an embodiment, the busbar spacer 500 may have a melting point temperature that is higher than the melting point temperature of the support frame 330.

When an event such as thermal runaway occurs inside the battery module 10, the temperature inside the housing 200 may rise to about 1000 degrees Celsius or more. In some cases, the melting point of the support frame 330 may have, for example, a melting point of about 110 to 130 degrees Celsius. Accordingly, when thermal runaway occurs, the support frame 330 may melt.

In an embodiment, a busbar spacer 500 according to the embodiment may be provided to have a melting point temperature higher than the melting point temperature of the support frame 330. In another embodiment, the busbar spacer 500 may have a melting point higher than the internal temperature of the housing 200 during thermal runaway.

For example, in one embodiment the melting point temperature of the busbar spacer 500 may be higher than about 1000 degrees Celsius. In another embodiment, the busbar spacer 500 may include a heat-resistant material that may withstand a temperature of about 1200 degrees Celsius for about 5 minutes or more without melting. In one embodiment the protrusion 520 may keep the adjacent busbars 310 spaced apart from each other able to withstand a temperature of about 1200 degrees Celsius without melting.

In an embodiment the busbar spacer 500 fixed to the support frame 330 prevents the one or more busbars 310 of the plurality of busbars from becoming misaligned as the support frame 330 melts under high temperature conditions. In some embodiments, the high temperature conditions are temperatures higher than the melting point temperature of the support frame. In some embodiments, the busbar spacer 500 prevents the one or more of the plurality of busbars 310 from contacting each other at high temperatures, resulting in short circuits.

However, the numerical values of the temperature at the time of occurrence of the thermal runaway described above, the melting point of the support frame 330, and the melting point of the busbar spacer 500 are illustrative, and the present disclosure is not necessarily limited to the temperature described above. For example, if the temperature of the melting point of the support frame 330 is higher than the temperature of the melting point of the support frame 330, it will considered to belong to the present disclosure.

As set forth above, short circuits between multiple busbars may be prevented with the use of busbar spacers or battery modules containing busbar spacers therein.

In a battery module according to an embodiment, the arrangement of multiple busbars may be supported when a high temperature event such as thermal runaway or the like occurs. Additionally, the busbar spacers and battery modules as described herein can be used to prevent short circuits in secondary batteries by preventing melting of busbar supports and subsequent electrical contact of adjacent busbars.

While the example embodiments have been illustrated and described above, it will be apparent to those skilled in the art that modifications and variations could be made without departing from the scope of the present disclosure as defined by the appended claims.

What is claimed is:

1. A battery module comprising:
a cell assembly comprising a plurality of battery cells;
a support frame disposed on at least one side of the cell assembly;
a plurality of busbars disposed on the support frame and electrically connecting the plurality of battery cells; and
a busbar spacer at least partially disposed between the plurality of busbars and separating adjacent busbars among the plurality of busbars.

2. The battery module of claim 1, wherein a melting point temperature of the busbar spacer is higher than a melting point temperature of the support frame.

3. The battery module of claim 1, wherein the plurality of busbars and the busbar spacer are disposed to face each other with the support frame interposed therebetween.

4. The battery module of claim 3, wherein the busbar spacer is disposed between the support frame and the cell assembly, and at least partially protrudes to be disposed between the plurality of busbars.

5. The battery module of claim 1, wherein the busbar spacer includes,
a spacer body provided to face the support frame; and
a protrusion protruding from the spacer body toward a gap between the plurality of busbars.

6. The battery module of claim 5, wherein the protrusion includes,
a first protrusion supporting a first surface of the plurality of busbars, facing the cell assembly; and
a second protrusion protruding further than the first protrusion and supporting a second surface opposite to the first surface.

7. The battery module of claim 6, wherein the first protrusion includes a first support contacting the first surface of the plurality of busbars,
the second protrusion includes a second support contacting the second surface of the plurality of busbars, and
at least one of the plurality of busbars is disposed and inserted between the first support and the second support.

8. The battery module of claim 5, wherein the support frame includes a spacer hole provided between the plurality of busbars so that at least a portion of the protrusion is inserted thereinto.

9. The battery module of claim 6, wherein the first protrusion and the second protrusion are disposed alternately.

10. The battery module of claim 6, wherein at least one first protrusion and at least one second protrusion are provided; and
the first protrusion is disposed between a plurality of the second protrusions.

11. The battery module of claim 7, wherein the second support includes a hook on which edges of a plurality of adjacent busbars are caught.

12. The battery module of claim 5, wherein the spacer body has a height greater than a height of the plurality of busbars.

13. A battery module comprising:
a cell assembly including a plurality of battery cells;
a support frame disposed to face the cell assembly;
a plurality of busbars disposed on the support frame and including a first busbar and a second busbar adjacent to each other; and
a busbar spacer at least partially disposed between the first busbar and the second busbar, and coupling the first busbar and the second busbar to each other.

14. The battery module of claim 13, wherein the plurality of busbars and the busbar spacer are disposed to face each other with the support frame interposed therebetween; and wherein
the busbar spacer comprises:
a spacer body disposed between the support frame and the cell assembly; and
a protrusion protruding from the spacer body toward a space between the first busbar and the second busbar.

15. The battery module of claim 14, wherein the protrusion includes,
a first protrusion supporting a first surface of the first busbar and the second busbar; and
a second protrusion at least partially disposed between the first busbar and the second busbar, and supporting a second surface of the first busbar and the second busbar, opposite to the first surface.

16. The battery module of claim 15, wherein the first busbar and the second busbar are configured to be coupled to each other while being at least partially interposed between the first protrusion and the second protrusion.
